(19) United States
(12) Patent Application Publication
(10) Pub. No.: US 2017/0169438 A1
(43) Pub. Date: Jun. 15, 2017

(54) USING A SATISFACTION-PREDICTION MODEL TO FACILITATE CUSTOMER-SERVICE INTERACTIONS

(71) Applicant: Zendesk, Inc., San Francisco, CA (US)

(72) Inventors: Jason Edward Maynard, San Francisco, CA (US); Michael G. Mortimer, Croydon Hills (AU); Sean D. Caffery, Collingwood (AU); Christopher J. Hausler, Coburg (AU); Anh Thien Dinh, Pascoe Vale (AU); Narek Amirbekian, San Francisco, CA (US); Beau Jonathan Fabry, San Francisco, CA (US); Jeffrey P. Theobald, Southbank (AU); Thomas Pelletier, Montpellier (FR)

(73) Assignee: Zendesk, Inc., San Francisco, CA (US)

(21) Appl. No.: 14/968,666

(22) Filed: Dec. 14, 2015

(51) Int. Cl. G06Q 30/00

(52) U.S. Cl. CPC G06Q 30/016

(57) ABSTRACT

The disclosed embodiments provide a system that uses a predicted probability of satisfaction for a customer to facilitate a customer-service interaction. During operation, the system obtains information related to an ongoing customer-service interaction involving the customer. The system uses the obtained information to determine a probability that the customer will be satisfied with the customer-service interaction. Next, the system uses the determined probability that the customer will be satisfied to facilitate subsequent interactions whether automated or manual with the customer in furtherance of the customer-service interaction.

### BACKGROUND

Field

The disclosed embodiments generally relate to computer-based support applications that aid businesses in managing customer-service interactions, such as help desk applications. More specifically, the disclosed embodiments relate to using a satisfaction-prediction model to proactively identify negative or positive customer-service interactions in a customer-support system.

Related Art

Businesses typically wish to receive feedback about their customer-service relationships. By carefully analyzing this feedback, businesses are often able to improve their customer-service processes to increase overall customer satisfaction. This can create a considerable competitive advantage for businesses that operate in a modern, service-oriented business environment.

However, conventional techniques for analyzing and using customer feedback information are often very crude. Businesses typically use feedback to retroactively detect high-level customer-satisfaction problems that require large-scale structural changes in their customer-service processes. Such large-scale structural changes are often beneficial. However, businesses have so far not been able to effectively exploit the ability of modern data-analysis techniques to predict customer-service issues with specific types of feedback received from individual customers in real-time. Such correlations can potentially be used to guide customer-service interactions for individual customers based on the feedback they provide.

Hence, what is needed are techniques for using data-analysis techniques to tailor customer-service interactions for individual customers.

### SUMMARY

The disclosed embodiments provide a system that uses a predicted probability of satisfaction for a customer to facilitate a customer-service interaction. During operation, the system obtains information related to an ongoing customer-service interaction involving the customer. The system uses the obtained information to determine a probability that the customer will be satisfied with the customer-service interaction. Next, the system uses the determined probability that the customer will be satisfied to facilitate subsequent interactions whether automated or manual with the customer in furtherance of the customer-service interaction.

In some embodiments, while obtaining the information related to the customer-service interaction, the system obtains one or more of the following: (1) phrases extracted from communications between the customer and a customer-service agent; (2) performance and operational metrics associated with the customer-service interaction; (3) customer data associated with the requester of the customer-service interaction; and (4) configurable attributes associated with the customer-service interaction, wherein the configurable settings can be: selected by the customer, selected by a customer-service agent, or automatically selected based on automated business rules.

In some embodiments, while using the obtained information to determine the probability that the customer will be satisfied, the system uses a machine-learning model that operates on signals derived from the obtained information to determine the probability that the customer will be satisfied.

In some embodiments, prior to determining the probability that the customer will be satisfied, the system trains the machine-learning model based on information related to previous customer-service interactions along with feedback information indicating whether customers were satisfied with the previous customer-service interactions.

In some embodiments, while using the determined probability to facilitate the subsequent interactions with the customer, the system presents the determined probability through a user interface to a customer-service agent who is handling the customer-service interaction.

In some embodiments, while using the determined probability to facilitate the subsequent interactions with the customer, the system prioritizes or segments a set of customer-service interactions for a customer-service agent based on probabilities that customers will be satisfied with the customer-service interactions. This enables the customer-service representative to focus on higher-priority customer-service interactions that are more likely to lead to customer dissatisfaction.

In some embodiments, while using the determined probability to facilitate the subsequent interactions with the customer, the system automatically triggers an action in furtherance of the customer-service interaction based on a pre-specified business rule.

In some embodiments, while using the determined probability to facilitate the subsequent interactions with the customer, the system identifies which signals derived from the obtained information are most predictive of customer satisfaction or dissatisfaction.

In some embodiments, whenever a customer-service interaction is updated (for example, based on a subsequent action by the customer, a subsequent action by a customer-service agent, or a subsequent automatic action), the system repeats the operations of: obtaining the information, determining the probability that the customer will be satisfied, and using the determined probability to facilitate subsequent interactions with the consumer.

In some embodiments, at regular time intervals, the system repeats the operations of: obtaining the information, determining the probability that the customer will be satisfied, and using the determined probability to facilitate subsequent interactions with the consumer.

In some embodiments, the customer-service interaction is associated with a ticket in a help desk ticketing system.

### BRIEF DESCRIPTION OF THE FIGURES

FIG. 1A illustrates a computing environment including an application and associated ticketing system in accordance with the disclosed embodiments.

FIG. 1B illustrates a ticketing system that uses a satisfaction-prediction model to facilitate customer-service interactions in accordance with the disclosed embodiments.

FIG. 2 presents a flow chart illustrating the process of using a satisfaction-prediction model to facilitate a customer-service interaction in accordance with the disclosed embodiments.

FIG. 3 presents a flow chart illustrating several ways that a prediction for customer satisfaction can be used to facilitate a customer-service interaction in accordance with disclosed embodiments.

FIG. 4 presents a flow chart illustrating how the satisfaction-prediction model is periodically trained and updated in accordance with the disclosed embodiments.

FIG. 5 presents a user interface that displays an exemplary list of unresolved tickets in accordance with the disclosed embodiments.

FIG. 6 presents a user interface for specifying an automatically triggered rule in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Computing Environment

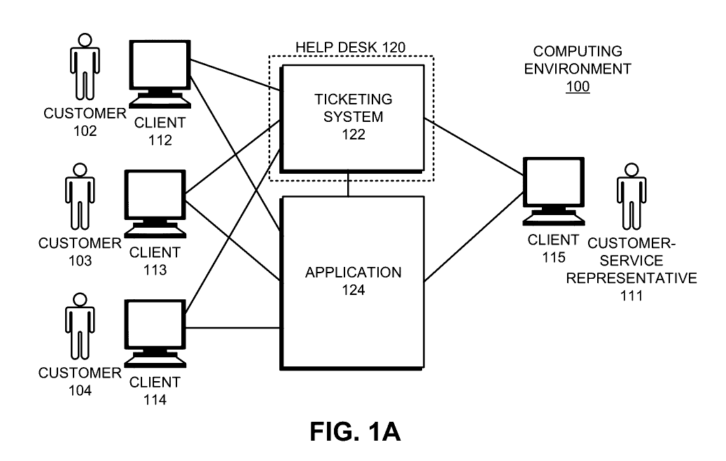

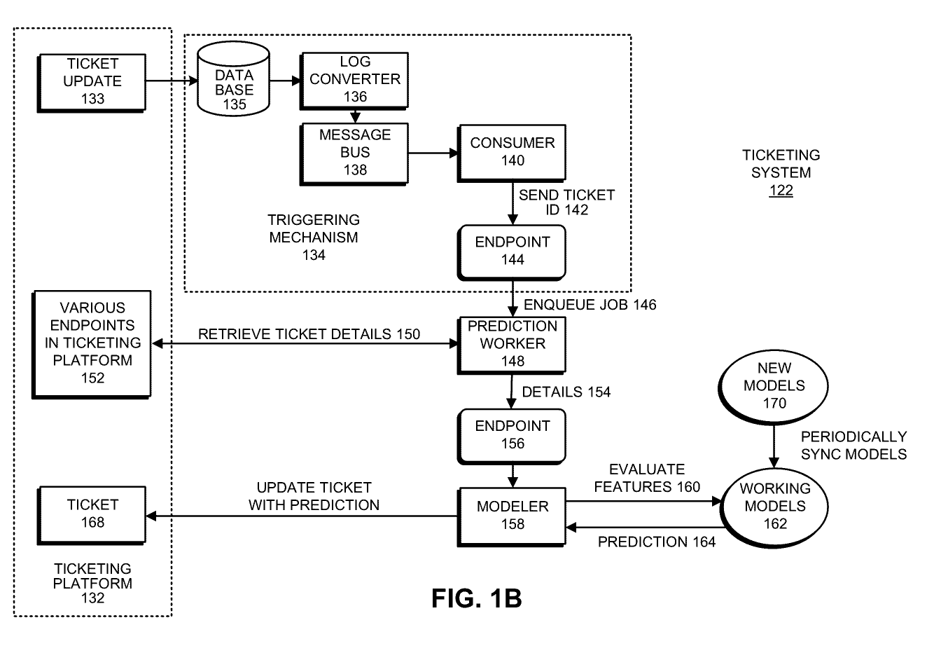

FIG. 1A illustrates a computing environment 100 including an application 124 and ticketing system 122 in accordance with the disclosed embodiments. Within computing environment 100, a number of customers 102-104 interact with an application 124 through client computer systems 112-114, respectively. Application 124 is provided by an organization, such as a commercial enterprise, to enable customers 102-104 to perform various operations associated with the organization, or to access one or more services provided by the organization. For example, application 124 can include online accounting software that customers 102-104 can access to prepare and file tax returns online. In another example, application 124 provides a commercial website for selling sporting equipment. Note that application 124 can be hosted on a local or remote server.

If customers 102-104 have problems or questions about application 124, they can access a help desk 120 to obtain help in dealing with issues, which can include various problems and questions. For example, a user of accounting software may need help in using a feature of the accounting software, or a customer of a website that sells sporting equipment may need help in cancelling an order that was erroneously entered. This help may be provided by a customer-service representative 111 who operates a client computer system 115 and interacts with customers 102-104 through help desk system 120. Note that customer-service representative 111 can access application 124 (either directly or indirectly through help desk 120) to help resolve an issue.

Help desk system 120 organizes customer issues using a ticketing system 122, which generates tickets to represent each customer issue. The structure of ticketing system 122 is described in more detail below with reference to FIG. 1B.

### Ticketing System

FIG. 1B illustrates an exemplary ticketing system 122 that uses a satisfaction-prediction model to facilitate customer-service interactions in accordance with the disclosed embodiments. Ticketing systems are typically associated with a physical or virtual “help desk” for resolving customer problems. Note that although the present invention is described with reference to a ticketing system, it is not meant to be limited to customer-service interactions involving ticketing systems. In general, the invention can be applied to any type of system that enables a customer to resolve a problem with a product or service provided by an organization.

Ticketing system 122 includes a ticketing platform 132, which comprises a set of software resources that enable a customer to resolve an issue. Note that specific issues are associated with abstractions called “tickets,” which encapsulate various data and metadata associated with the specific issues. For example, an exemplary ticket can include a ticket identifier, and information (or links to information) associated with the problem. For example, this information can include: (1) information about the problem, (2) customer information for one or more customers who are affected by the problem, (3) agent information for one or more customer-service agents who are interacting with the customer, (4) email and other electronic communications about the problem, (5) information about telephone calls associated with the problem, (6) timeline information associated with customer-service interactions to resolve the problem, including response times and resolution times, such as a first reply time, a time to full resolution and a requester wait time, and (7) effort metrics, such as number of communications or responses by a customer, a number of times a ticket has been reopened, and a number of times the ticket has been reassigned to a different customer-service agent.

Suppose that during operation of ticketing platform 132, a ticket update 133 occurs, wherein this ticket update 133 can be associated with creation of a new ticket, or an update to an existing ticket. When the ticket update 133 occurs, a binary log associated with the update is written to a local database 135. This triggers a log converter 136 to convert the binary log into another form, such as JavaScript Object Notation (JSON), which feeds into a message bus 138. (Note that message bus 138 can be implemented using a message broker system, such as Apache Kafka™.)

This information is streamed from the message bus 138 to a consumer 140, which examines the stream looking for anything that is a creation event or an update event. If such an event is detected, consumer 140 sends a ticket identifier 142 to an endpoint 144. This causes a corresponding job to be enqueued 146 for a prediction worker 148. Note that database 135, log converter 136, message bus 138, consumer 140 and endpoint 144 collectively function as a triggering mechanism 134 that triggers generation of a prediction about customer satisfaction for specific tickets.

Next, prediction worker 148 processes the enqueued job. During this process, the system first retrieves ticket details from various endpoints 152 within ticketing platform 132. The retrieved ticket details 150 comprise a feature set that comprises various signals to be evaluated by one or more models 162. For example, this feature set can include: (1) words extracted from communications between the customer and a customer-service agent, including all communications across various channels, such as email, text messages and voice messages; (2) performance metrics associated with the customer-service interaction; and (3) configurable settings associated with the customer-service interaction, wherein the configurable settings are: selected by the customer, selected by a customer-service agent, or are pre-selected. For example, the configurable settings can include: a priority of a ticket that is set by a customer-service agent or the customer; a ticket type (e.g., incident resolution, service request, questions), a customer plan (e.g., elite plan, regular plan); and a severity of issue (is this a tier 1 issue?). These configurable settings can be obtained from a number of sources, including: ticket metadata, user metadata, metadata for a customer-service representative, and organization metadata for an organization that provides a product or a service to the customer. Note that the above-listed feature set components are merely exemplary. In general, any type of data that is associated with a customer-service interaction can be incorporated as a component into the feature set.

Next, prediction worker 148 sends the retrieved ticket details 154 to another endpoint 156. A worker called a modeler 158 subsequently generates all of the features for the model (which are also referred to as “signals”) from the retrieved ticket details 154. For example, this process can involve breaking textual information contained in various communications related to the customer-service interaction into n-grams, such as unigrams, bigrams and trigrams. This facilitates correlating the occurrence of specific n-grams in the customer communications with positive or negative outcomes. For example, if a customer uses any of the n-grams “frustrated,” “really tired” or “out to lunch” in a communication, the customer-satisfaction model may predict that the customer is likely to be unsatisfied.

Next, modeler 158 evaluates these features 160 against models 162 to return a prediction 164. For example, prediction 164 can specify a probability that the customer will provide a favorable review after the problem associated with the ticket is ultimately resolved.

Note that models 162 can include one or more machine-learning models that operate on an input comprising features provided by modeler 158 to generate an output comprising a probability of a favorable review by the consumer. For example, in some embodiments, models 162 comprise machine-learning models defined in Python scikit-learn. (See Scikit-learn: Machine Learning in Python, Pedregosa, et al., JMLR 12, pp. 2825-2830, 2011.)

In general, any type of machine-learning model (or other type of predictive model) can be used to predict subsequent customer feedback based on features associated with a customer-service ticket. For example, the system can use machine-learning models based on: decision-tree learning techniques, association rule learning techniques, artificial neural networks, inductive logic programming, support vector machines, clustering techniques, Bayesian networks, reinforcement learning techniques, representation learning techniques and genetic algorithms.

In some embodiments, models 162 comprises three different models, including: (1) a model for words extracted from communications between the customer and a customer-service agent; (2) a model for performance metrics associated with the customer-service interaction; (3) customer data associated with the requester of the customer-service interaction; and (4) a model for configurable settings associated with the customer-service interaction. The output of these models can be combined (for example, through a voting operation) to generate a prediction.

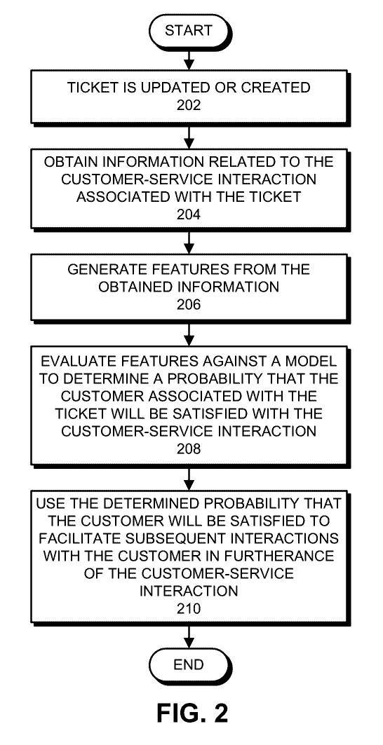

When a prediction 164 is finally returned, modeler 158 updates a corresponding ticket 168 maintained in ticketing platform 132 with this prediction 164. This update facilitates subsequent interactions with the customer as is described in more detail below with reference to the flow chart that appears in FIG. 2.

The system also maintains a set of “new models” 170 that are periodically trained based on information related to the most recently completed customer-service interactions along with feedback information indicating whether customers were satisfied with the customer-service interactions. During normal system operation, the working models 162 are periodically synchronized with the new models 170. For example, this synchronization can take place once a day. This ensures that the working models 162 are consistent with more recent customer-service interactions.

### Using a Satisfaction Prediction to Facilitate a Customer-Service Interaction

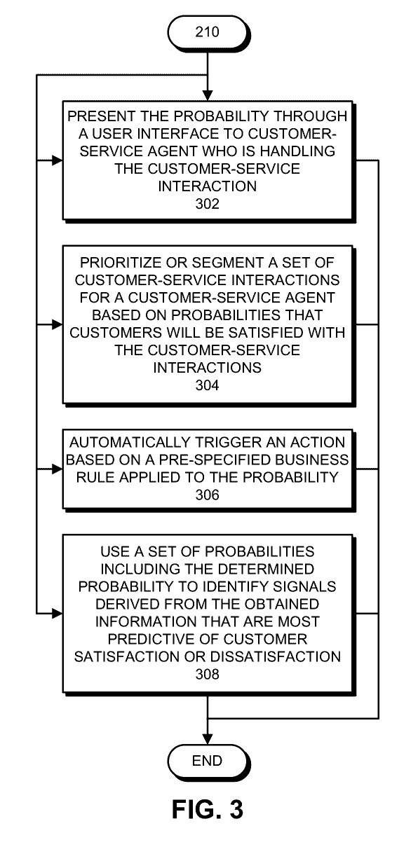

FIG. 2 presents a flow chart illustrating the process of using a satisfaction-prediction model to facilitate a customer-service interaction in accordance with the disclosed embodiments. As mentioned above, this process is triggered when a ticket is updated or created or when a periodic timer expires (step 202). In response to this triggering event, the system obtains information related to an ongoing customer-service interaction involving the customer (step 204). Next, the system generates features (also referred to as “signals”) from the obtained information (step 206). The system then evaluates the features against a model to determine a probability that the customer associated with the ticket will be satisfied with the customer-service interaction (step 208). Note the system can use different models for different businesses, and for different subsets of customers for each business. Finally, the system uses the determined probability that the customer will be satisfied to facilitate subsequent interactions with the customer in furtherance of the customer-service interaction (step 210). These subsequent actions are described in more detail below with reference to the flow chart that appears in FIG. 3.

In an alternative embodiment, instead of correlating features of a customer-service interaction with a probability that the customer will be satisfied, the system correlates the features with a probability that the customer will buy additional services and products from the business. This is known as a “probability of customer conversion.”

FIG. 3 presents a flow chart illustrating a number of ways that a prediction for customer satisfaction can be used to facilitate a customer-service interaction in accordance with disclosed embodiments. (Note that this flow chart expands on the operation represented in step 210 of the flow chart that appears in FIG. 2.) The flow chart in FIG. 3 illustrates four different possible ways to facilitate a customer-service interaction, which are associated with steps 302, 304, 306 and 308.

First, the system can present the determined probability through a user interface to a customer-service agent who is handling the customer-service interaction (step 302). Providing this probability information to a customer-service representative can be quite useful. For example, if the determined probability is automatically received by a customer-service representative after the customer-service representative responds to a customer, the customer-service representative can gain some insight about whether the response to the customer will make the customer more likely to be satisfied.

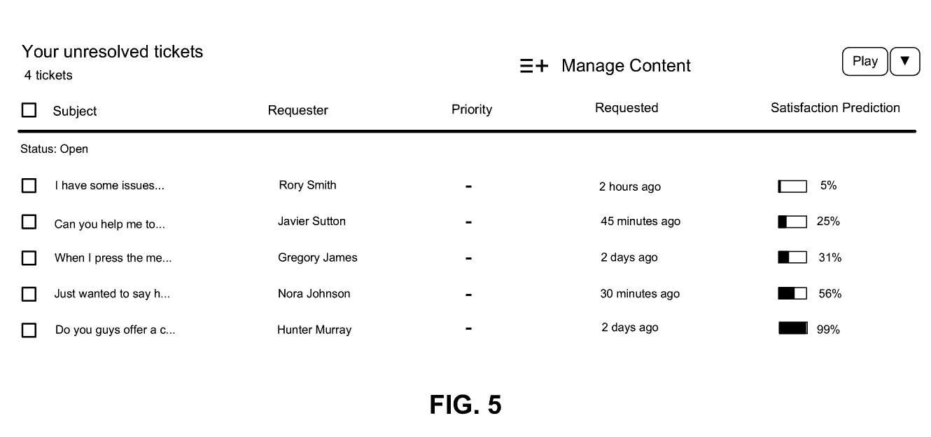

Alternatively, the system can prioritize or segment a set of customer-service interactions for a customer-service agent based on probabilities that customers will be satisfied with the customer-service interactions (step 304). This enables the customer-service representative to focus on higher-priority customer-service interactions that are more likely to lead to customer dissatisfaction. For example, a customer-service representative can examine all open tickets she is handling and can sort them by probability of receiving an unfavorable rating. This enables the customer-service representative to focus on the tickets that are most at risk of receiving an unfavorable rating first. An exemplary display of open tickets for a customer-service representative is illustrated in FIG. 5. Note that the tickets in this list are sorted from lowest to highest probability of receiving a favorable rating. This means that the tickets that are most likely to lead to customer dissatisfaction are displayed at the top of this list.

The system can also automatically trigger an action in furtherance of the customer-service interaction based on a pre-specified business rule (step 306). For example, each time a ticket is updated, the probability of receiving an unfavorable rating along with other signals can feed into a rules engine that automatically fires rules that trigger actions based on the inputs.

Many possible actions can be triggered. For example, the system can: (1) escalate the matter and send it to a support manager (or possibly to the head of support); (2) notify one or more individuals associated with the matter within an organization about the problematic ticket; or (3) trigger an action in a downstream system, such as a customer relationship management (CRM) system.

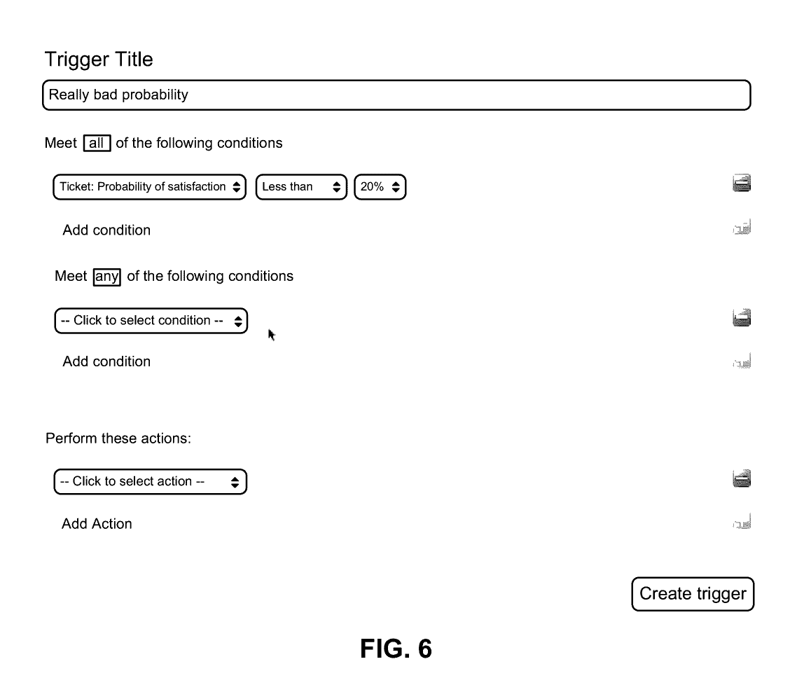

An exemplary user interface for specifying a rule that automatically triggers an action is illustrated in FIG. 6. This user interface comprises a number of fields, including a field for entering a title for the rule (referred to as a “trigger title”). It provides dropdowns that enable the user to specify triggering conditions for the rule, such as “the probability of user satisfaction is less than 20%” or “the ticket is a high priority ticket.” It also provides dropdowns that enable the user to specify an action to be triggered, such as “sending an email to support manager about the ticket.” It additionally provides a button to create a rule for a triggered action. After the rule is specified, the system continually monitors open tickets to see whether any tickets satisfy the rule. If so, the system triggers the associated action.

The system can also identify which signals derived from the ticket information are most predictive of customer satisfaction or dissatisfaction (step 308). This information about predictive signals can be used to prioritize various aspects of interactions with customers. For one set of customers, such as purchasers of a software product, reply time may be extremely important for customer satisfaction. In this case, customer-service agents dealing with this set of customers should be very sensitive about reply time. On the other hand, for another set of customers associated with an internal help desk within a company, reply time may be somewhat less important, so agents dealing with this set of customers can be less sensitive about reply time.

### Updating the Satisfaction-Prediction Model

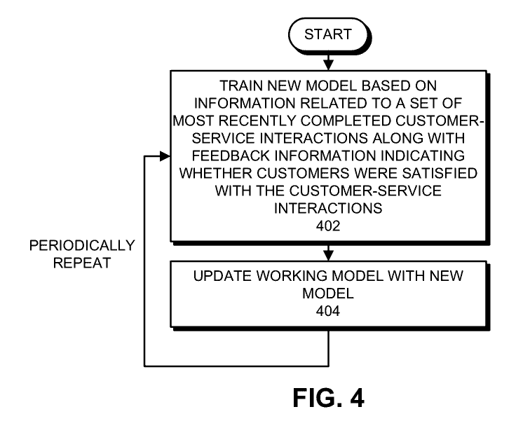

FIG. 4 presents a flow chart illustrating how the satisfaction-prediction model can be periodically trained and updated in accordance with the disclosed embodiments. First, the system trains a new model based on information related to a set of most recent customer-service interactions along with feedback information indicating whether customers were satisfied with the customer-service interactions (step 402). Next, the system updates the working model with the new model (step 404). Note that this updating process is repeated at periodic intervals, for example once a day or once a week.

The feedback information received from the customers is not meant to be limited to a binary indication of whether the customer was satisfied or not. In other embodiments, the feedback information can include a rating (for example on a scale of one to five) indicating how satisfied the customer was with the customer-service interaction. In addition to ratings for overall customer satisfaction, these ratings can include ratings for different aspects of the customer-service interaction, including ratings for timeliness, politeness and effectiveness of the customer-service representative. This feedback information can also include individual ratings for specific customer-service representatives.

The working model can also produce a number of different types of outputs and is not limited to simply predicting a probability that a customer will be satisfied. For example, in cases where the feedback information includes numerical ratings, the model can predict an average rating for the customer-service interaction.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for using a predicted probability of satisfaction for a customer to facilitate a customer-service interaction, comprising:
obtaining information related to an ongoing customer-service interaction involving the customer;
using the obtained information to determine a probability that the customer will be satisfied with the customer-service interaction; and
using the determined probability that the customer will be satisfied to facilitate subsequent interactions with the customer in furtherance of the customer-service interaction.

2. The method of claim 1, wherein obtaining the information related to the customer-service interaction includes obtaining one or more of the following:
phrases or individual words extracted from communications between the customer and a customer-service agent;
performance and operational metrics associated with the customer-service interaction;
customer data associated with the customer interaction; and
configurable attributes associated with the customer-service interaction, wherein the configurable attributes are: selected by the customer, selected by a customer-service agent, or automatically selected based on automated business rules.

3. The method of claim 1, wherein using the obtained information to determine the probability that the customer will be satisfied involves using a machine-learning model that operates on signals derived from the obtained information to determine the probability that the customer will be satisfied.

4. The method of claim 3, wherein prior to determining the probability that the customer will be satisfied, the method further comprises training the machine-learning model based on information related to previous customer-service interactions along with feedback information indicating whether customers were satisfied with the previous customer-service interactions.

5. The method of claim 1, wherein using the determined probability to facilitate the subsequent interactions with the customer includes presenting the determined probability through a user interface to a customer-service agent who is handling the customer-service interaction.

6. The method of claim 1, wherein using the determined probability to facilitate the subsequent interactions with the customer includes prioritizing or segmenting a set of customer-service interactions for a customer-service agent based on probabilities that customers will be satisfied with the customer-service interactions.

7. The method of claim 1, wherein using the determined probability to facilitate the subsequent interactions with the customer includes automatically triggering an action in furtherance of the customer-service interaction based on a pre-specified business rule applied to the determined probability.

8. The method of claim 1, wherein using the determined probability to facilitate the subsequent interactions with the customer includes using a set of probabilities including the determined probability to identify signals derived from the obtained information that are most predictive of customer satisfaction or dissatisfaction.

9. The method of claim 1, wherein the method is repeated each time a customer-service interaction is updated based on: a subsequent action by the customer, a subsequent action by a customer-service agent, or a subsequent automatic action.

10. The method of claim 1, wherein the method is repeated periodically based on a timer.

11. The method of claim 1, wherein the customer-service interaction is associated with a ticket in a help desk ticketing system.

12. A non-transitory computer-readable storage medium storing instructions that when executed by a computer cause the computer to perform a method for using a predicted probability of satisfaction for a customer to facilitate a customer-service interaction, the method comprising:
obtaining information related to an ongoing customer-service interaction involving the customer;
using the obtained information to determine a probability that the customer will be satisfied with the customer-service interaction; and
using the determined probability that the customer will be satisfied to facilitate subsequent interactions with the customer in furtherance of the customer-service interaction.

13. The non-transitory computer-readable storage medium of claim 12, wherein obtaining the information related to the customer-service interaction includes obtaining one or more of the following:
phrases or individual words extracted from communications between the customer and a customer-service agent;
performance and operational metrics associated with the customer-service interaction;
customer data associated with the customer interaction; and
configurable attributes associated with the customer-service interaction, wherein the configurable attributes are: selected by the customer, selected by a customer-service agent, or automatically selected based on automated business rules.

14. The non-transitory computer-readable storage medium of claim 12, wherein using the obtained information to determine the probability that the customer will be satisfied involves using a machine-learning model that operates on signals derived from the obtained information to determine the probability that the customer will be satisfied.

15. The non-transitory computer-readable storage medium of claim 14, wherein prior to determining the probability that the customer will be satisfied, the method further comprises training the machine-learning model based on information related to previous customer-service interactions along with feedback information indicating whether customers were satisfied with the previous customer-service interactions.

16. The non-transitory computer-readable storage medium of claim 12, wherein using the determined probability to facilitate the subsequent interactions with the customer includes presenting the determined probability through a user interface to a customer-service agent who is handling the customer-service interaction.

17. The non-transitory computer-readable storage medium of claim 12, wherein using the determined probability to facilitate the subsequent interactions with the customer includes prioritizing or segmenting a set of customer-service interactions for a customer-service agent based on probabilities that customers will be satisfied with the customer-service interactions.

18. The non-transitory computer-readable storage medium of claim 12, wherein using the determined probability to facilitate the subsequent interactions with the customer includes automatically triggering an action in furtherance of the customer-service interaction based on a pre-specified business rule applied to the determined probability.

19. The non-transitory computer-readable storage medium of claim 12, wherein using the determined probability to facilitate the subsequent interactions with the customer includes using a set of probabilities including the determined probability to identify signals derived from the obtained information that are most predictive of customer satisfaction or dissatisfaction.

20. The non-transitory computer-readable storage medium of claim 12, wherein the method is repeated each time a customer-service interaction is updated based on: a subsequent action by the customer, a subsequent action by a customer-service agent, or a subsequent automatic action.

21. A system that uses a predicted probability of satisfaction for a customer to facilitate a customer-service interaction, comprising:
at least one processor and at least one associated memory; and
a customer-service platform that executes on the at least one processor, wherein during operation, the customer-service platform:
obtains information related to an ongoing customer-service interaction involving the customer;
uses the obtained information to determine a probability that the customer will be satisfied with the customer-service interaction; and
uses the determined probability that the customer will be satisfied to facilitate subsequent interactions with the customer in furtherance of the customer-service interaction.

22. The system of claim 21, wherein while obtaining the information related to the customer-service interaction, the customer-service platform obtains one or more of the following:
phrases or individual words extracted from communications between the customer and a customer-service agent;
performance and operational metrics associated with the customer-service interaction;
customer data associated with the customer interaction; and
configurable attributes associated with the customer-service interaction, wherein the configurable attributes are: selected by the customer, selected by a customer-service agent, or automatically selected based on automated business rules.

23. The system of claim 21, wherein while using the obtained information to determine the probability that the customer will be satisfied, the customer-service platform uses a machine-learning model that operates on signals derived from the obtained information to determine the probability that the customer will be satisfied.

24. The system of claim 23, wherein prior to determining the probability that the customer will be satisfied, the customer-service platform trains the machine-learning model based on information related to previous customer-service interactions along with feedback information indicating whether customers were satisfied with the previous customer-service interactions.

25. The system of claim 21, wherein while using the determined probability to facilitate the subsequent interactions with the customer, the customer-service platform presents the determined probability through a user interface to a customer-service agent who is handling the customer-service interaction.

26. The system of claim 21, wherein while using the determined probability to facilitate the subsequent interactions with the customer, the customer-service platform prioritizes or segments a set of customer-service interactions for a customer-service agent based on probabilities that customers will be satisfied with the customer-service interactions.

27. The system of claim 21, wherein while using the determined probability to facilitate the subsequent interactions with the customer, the customer-service platform automatically triggers an action in furtherance of the customer-service interaction based on a pre-specified business rule applied to the determined probability.

28. The system of claim 21, wherein while using the determined probability to facilitate the subsequent interactions with the customer, the customer-service platform uses a set of probabilities including the determined probability to identify signals derived from the obtained information that are most predictive of customer satisfaction or dissatisfaction.

29. The system of claim 21, wherein each time a customer-service interaction is updated based on: a subsequent action by the customer, a subsequent action by a customer-service agent, or a subsequent automatic action, the customer-service platform repeats the operations of: obtaining the information, determining the probability that the customer will be satisfied, and using the determined probability to facilitate subsequent interactions with the consumer.
